(19) United States
(12) Patent Application Publication
(10) Pub. No.: US 2016/0002574 A1
(43) Pub. Date: Jan. 7, 2016

(54) Cleaning Gas and Cleaning Method

(71) Applicant: CENTRAL GLASS COMPANY, LIMITED, Ube-shi, Yamaguchi (JP)

(72) Inventors: Hiroyuki OOMORI, Ube-shi, Yamaguchi (JP); Akiou KIKUCHI, Ube-shi, Yamaguchi (JP); Tomonori UMEZAKI, Ube-shi, Yamaguchi (JP)

(73) Assignee: CENTRAL GLASS COMPANY, LIMITED, Yamaguchi (JP)

(21) Appl. No.: 14/767,846

(22) PCT Filed: Jan. 24, 2014
(86) PCT No.: PCT/JP2014/051453

§ 371 Date: Aug. 13, 2015

(30) Foreign Application Priority Data
Feb. 14, 2013 (JP) 2013-026318

(51) Int. Cl. C11D 7/04; C11D 11/00; B08B 7/00

(52) U.S. Cl. CPC C11D 7/04; B08B 7/0071; C11D 11/0041

(57) ABSTRACT

A cleaning gas according to the present invention is intended for removing a silicon carbide-containing deposit on a base of at least partially graphitized carbon and is characterized by containing iodine heptafluoride. It is possible by the use of such a cleaning gas to remove silicon carbide without etching of graphite.

### FIELD OF THE INVENTION

The present invention relates to a cleaning gas and cleaning method for removing a silicon carbide-containing deposit on a base.

### BACKGROUND ART.

Silicon carbide (SiC) is used as an important ceramic material in a wide range of fields. Attention is recently being given to the epitaxial growth of silicon carbide. The development of silicon carbide films is now pursued for applications such as low-power-consumption transistors because of the high breakdown voltage and high-temperature operation reliability of the silicon carbide films.

For use in such applications, silicon carbide needs to be produced in high-purity single crystal form. As methods for producing a large-size single crystal of silicon carbide, there are known a film growth method that involves chemical reaction of propane gas with silane gas etc. by chemical vapor deposition (CVD) process and a film growth method that uses monomethylsilane as a raw material of CVD process.

In the case of producing a high-purity single-crystal silicon carbide film, it is necessary to grow the silicon carbide film at a very high temperature of 1500° C. or higher. For this reason, high heat-resistant materials are used as materials of film growth equipment e.g. reactor inner wall, wafer susceptor etc. Graphite-containing materials are often used as those equipment materials (see Patent Document 1).

During the growth of the silicon carbide film by CVD process, silicon carbide gets deposited onto undesired equipment parts e.g. graphite reactor inner wall, susceptor etc. The silicon carbide deposit on the undesired equipment parts may fall off as fine particles, and then, get adhered to the growth surface of the silicon carbide film. The adhesion of such silicon carbide particles becomes a cause of interference with the crystal growth of the silicon carbide film or occurrence of defects in the silicon carbide film. Thus, the silicon carbide deposit has to be periodically removed from the reactor inner wall etc. As techniques for removal of the silicon carbide deposit on the reactor inner wall, it is conceivable to strip off the silicon carbide deposit from the reactor inner wall by means of a tool or to periodically replace the reactor with new one.

However, the strip-off of the silicon carbide deposit and the replacement of the reactor require a very long operation time, causes the reactor to be exposed to the atmospheric air for a long period of time and thereby leads to a detrimental influence on productivity such as deterioration of yield. Researches are therefore being made on cleaning methods that utilize gases capable of efficiently removing inorganic substances and chemically remove the silicon carbide deposit from the inside of the equipment by the use of these gases without the inside of the equipment being exposed to the atmospheric air.

Patent Documents 1 and 2 each disclose a semiconductor manufacturing apparatus for forming a SiC epitaxial film on a wafer mounted to a susceptor. It is described in these documents that a cleaning gas containing chlorine trifluoride (ClF₃) is used to remove a SiC film deposit on the susceptor.

Patent Document 3 discloses a method for etching silicon carbide by contact of chlorine trifluoride with a surface of the silicon carbide.

### PRIOR ART DOCUMENTS

### Patent Document

Patent Document 1: Japanese Laid-Open Patent Publication No. 2012-28385

Patent Document 2: Japanese Laid-Open Patent Publication No. 2012-54528

Patent Document 3: Japanese Laid-Open Patent Publication No. 2005-129724

### SUMMARY OF THE INVENTION

### Problems to be Solved by the Invention

As disclosed in Patent Documents 1 to 3, the chlorine trifluoride serves as good cleaning gas capable of efficiently removing silicon carbide only by thermal excitation e.g. heating without the need for plasma excitation. However, the chlorine trifluoride shows high reactivity such as corrosivity during cleaning of the reactor of the film growth equipment. This results in a problem that the material of the reactor is limited. It is thus common practice to use, as the material of the reactor, a material that does not noticeably react with the chlorine trifluoride.

Herein, the chlorine trifluoride is easy to react with graphite. In the case where the reactor and susceptor of the SiC film growth equipment is made of graphite, not only the silicon carbide as the removal target but also graphite surfaces of the reactor and susceptor are removed by cleaning with chlorine trifluoride gas so that there occurs damage to the graphite surfaces of the reactor and susceptor.

In order to improve the above damage problem, silicon carbide (SiC) coatings are applied by CVD process to the graphite surfaces of the reactor and susceptor by CVD in Patent Documents 1. and 2. In such a method, the silicon carbide coatings (dense polycrystal) on the graphite surfaces can be prevented from etching by etching rate control of the silicon carbide coatings (dense polycrystal) and the silicon carbide deposit (non-dense polycrystal).

The method of Patent Documents 1 and 2 however faces the problems that: the control of the cleaning treatment becomes complicated; and it is difficult to completely prevent etching of the silicon carbide coatings (dense polycrystal) on the graphite surfaces so that, while repeating the cleaning treatment, the graphite bases get exposed and eventually damaged.

In this way, there is a demand for methods to clean the silicon carbide deposit on the reactor inner wall, susceptor etc. during the growth of the silicon carbide film under the circumstances that attention is being given to the silicon carbide epitaxial growth techniques. However, none of the silicon carbide cleaning methods is yet satisfactory in view of comprehensive performance such as the materials of the reactor and susceptor, the cleaning efficiency, the ease of control of the cleaning treatment and the like. Further requirements are required for the silicon carbide cleaning methods.

The present invention has been carried out in view of the above problems. It is an object of the present invention to provide a cleaning gas and cleaning method for cleaning and removing a silicon carbide-containing deposit on a graphite-containing base at a sufficient cleaning rate without causing etching damage to graphite.

### Means for Solving the Problems

As a solution to the above problems, the present inventors have found that, by contact of an iodine heptafluoride-containing gas with a silicon carbide deposit on a base of graphitized carbon, it is possible to remove silicon carbide preferentially against graphite without causing remarkable etching damage to the graphite base. The present invention is based on such a finding.

Namely, the present invention provides a cleaning gas for removing a silicon carbide-containing deposit on a base of at least partially graphitized carbon, the cleaning gas comprising iodine heptafluoride.

In the present invention, the cleaning gas may contain at least one kind of oxidizing gas selected from the group consisting of F₂, ClF₃, COF₂, O₂, O₃, NO, NO₂, N₂O and N₂O₄.

The cleaning gas may further contain at least one kind of inert gas selected from the group consisting of He, Ne, Ar, Xe, Kr and N₂ in the present invention.

It is preferable in the present invention that the base is an inner wall or attachment device of silicon carbide single crystal production equipment, particularly for production of silicon carbide single crystals under high-temperature conditions of 1500° C. or higher. The silicon carbide single crystal production equipment is preferably for production of single-crystal silicon carbide films. As such film production equipment, particularly preferred is equipment for production of silicon carbide epitaxial films. The attachment device is preferably a susceptor for a semiconductor wafer.

The present invention also provides a cleaning method, comprising: while heating a base, removing a silicon carbide-containing deposit on the base by contact with the above cleaning gas.

The cleaning gas of the present invention enables efficient removal of the silicon carbide-containing deposit on the graphite base at a sufficient cleaning rate without causing etching damage to the graphite base. The cleaning method of the present invention, which utilizes the above cleaning gas, attains a higher clearing rate than those of conventional cleaning methods and thus enables shortening of cleaning time and significant reduction of damage to the graphite base with no fear of influence on the graphite base.

### BRIEF DESCRIPTION OF THE DRAWINGS

FIG. 1 is a schematic view of a cleaning apparatus used in each of Examples and Comparative Examples.

### DETAILED DESCRIPTION OF THE EMBODIMENTS

The cleaning gas of the present invention is characterized by containing iodine heptafluoride (sometimes simply referred to as “IF₇”) and is intended for removing a silicon carbide-containing deposit on a base of at least partially graphitized carbon without causing damage to the base.

The cleaning gas of the present invention will be hereinafter described below in detail.

There is no particular restriction on the iodine heptafluoride used in the cleaning gas of the present invention. It is feasible to purchase and use industrially produced iodine heptafluoride. The iodine heptafluoride can be produced and made available by a known production process as disclosed in e.g. Japanese Laid-Open Patent Publication No. 2009-23896 which is an application of the present applicant.

In the present invention, the iodine heptafluoride is generally contained in an amount of 1 to 100 vol %, preferably 10 to 100 vol %, in the cleaning gas. Although the iodine heptafluoride can be used solely, it is feasible to add various additives as appropriate depending on the purpose of use of the cleaning gas. For example, an oxidizing gas may be added as the additive in order to adjust the cleaning performance of the cleaning gas. An inert gas etc. may also be added as required. The addition of the oxidizing gas leads to an improvement in the cleaning rate of silicon carbide by the cleaning gas. The addition of the inert gas leads to a reduction in the cost of the cleaning gas while adjusting the cleaning rate of silicon carbide by the cleaning gas.

Examples of the oxidizing gas are: oxygen-containing gases such as O₂, O₃, CO₂, COCl₂, COF₂, N₂O, NO and NO₂; and halogen gases such as F₂, NF₃, Cl₂, Br₂, I₂, YFn (Y=Cl, Br or I; 1≦n≦5). Among others, O₂, NO₂, NO, COF₂, F₂, NF₃ and Cl₂ are preferred. In particular, O₂, NO₂ and NO are effective for improvement in the cleaning rate (see Examples).

The amount of the oxidizing gas added varies depending on the performance configuration of equipment to be cleaned and the cleaning conditions. In general, the amount of the oxidizing gas added is adjusted such that the volume ratio is in the range of iodine heptafluoride:oxidizing gas=10:90 to 90:10, preferably 30:70 to 70:30.

An reducing gas may be added in such an amount of iodine heptafluoride:reducing gas (volume ratio)=10:1 to 1:5, preferably 5:1 to 1:1. The amount of F radials, which perform the cleaning function, significantly decreases to cause a deterioration of productivity if the reducing gas is excessively added.

Further, a commonly used cleaning gas such as perfluorocarbon may be added in an amount of 1 to 99 vol % so as not to impair the effects of the cleaning gas of the present invention. Examples of such an additive cleaning gas are CF₄, CHF, CH₂F₂, CH₃F, C₂F₆, C₂F₄H₂, C₂F₅H, C₃F₈, C₃F₇H, C₃H₆H₂, C₃F₅H₃, C₃F₄H₄, C₃F₃H₅, C₃F₄H₂, C₃F₅H, C₃ClF₃H, C₄F₈, C₄F₆, C₅F₈ and C₅F₁₀.

In order to improve the cleaning performance of the cleaning gas, it is preferable to add a hydrogen halide such as HF, HCl or HBr to the cleaning gas. Among others, HF is particularly preferred. Although the cause of the phenomenon in which the cleaning performance can be improved with the addition of HF has not been made clear, it is assumed that the chemical bonds of the silicon carbide-containing deposit are weakened by the action of HF to allow an improvement in the cleaning rate.

The amount of the hydrogen fluoride (HF) added is adjusted such that the volume ratio is in the range of iodine heptafluoride:hydrogen fluoride=100:1 to 100:70, preferably 100:40 to 100:60.

The inert gas such as N₂, He, Ar, Ne or Kr may be added as appropriate in combination with the above oxidizing gas. In the case of adding the inert gas, it is feasible to add the inert gas in such a manner as to dilute the cleaning gas to an adequate concentration. There is no particular restriction on the concentration of the cleaning gas diluted by the inert gas. The amount of the inert gas added is generally 1 to 99 vol %, preferably 5 to 50 vol %, based on the total cleaning gas composition.

The cleaning method of the present invention, which utilizes the above cleaning gas, will be next described below in detail.

The deposit to be removed by the cleaning gas of the present invention is a deposit containing silicon carbide and formed on the base of at least partially graphitized carbon. In the present specification, the term “deposit” refers to an “unnecessary deposit” unless otherwise specified.

There is no particular restriction on the deposit as the removal target of the present invention as long as the silicon carbide is contained as a main component in the deposit. The deposit may be formed solely of silicon carbide. Examples of the deposit are those attendantly deposited, during production of silicon carbide thin films, thick films, powders, whiskers etc. by chemical vapor deposition (CVD) process, metal organic chemical vapor deposition (MOCVD) process, sputtering process, sol-gel process, evaporation process etc., on a reactor inner wall or attachment devices such as jigs, e.g., semiconductor wafer susceptor, pipes and the like of silicon carbide production equipment.

The removal target of the present invention is not limited to an unnecessary deposit in equipment for production of silicon carbide thin or thick films etc. and can alternatively be a unnecessary deposit on a reactor inner wail or attachment device of any other production equipment such as equipment for production of hexagonal SiC crystal wafers by large-size bulk crystal growth. For example, it is feasible in the present invention to remove an unnecessary deposit in equipment for large-size bulk crystal growth by sublimation recrystallization process (modified Lely process) in which a raw material for silicon carbide is subjected to sublimation by heating to grow a silicon carbide crystal on a seed crystal as disclosed in Japanese Laid-Open Patent Publication No. 2004-224663.

In the present invention, the base is any part made of at least partially graphitized carbon and capable of withstanding high-temperature conditions of 1500° C. or higher. The base may be formed solely of graphite or may be formed of graphite and coated with a protection film of silicon carbide etc. Specific examples of the base are component parts of the above silicon carbide production equipment, including a reactor inner wall and attachment devices such as jigs, e.g., semiconductor wafer susceptor, pipes and the like. Among others, the cleaning gas of the present invention is particularly suitable for application to the reactor inner wall and the semiconductor wafer susceptor on which the unnecessary deposit is likely to be formed.

The cleaning method of the present invention is carried out by, while heating the base by a heater external to the reactor, removing the silicon carbide-containing deposit on the base by contact with the iodine heptafluoride-containing cleaning gas. It is assumed that, when fluorine radicals are generated by thermal decomposition of the iodine heptafluoride in the cleaning gas, these radicals react with a silicon (Si) component of the silicon carbide in the deposit so as to remove the unnecessary deposit from the part.

In general, a higher fluorinated iodine compound such as IF₇ is decomposed by heating to a lower fluorinated iodine compound such as IF₅ and fluorine radicals as indicated by the following scheme (1). A conventionally used silicon carbide cleaning gas ClF₃ is decomposed by heating in the same manner as indicated by the following scheme (2).

IF₇→I5₇+2F⁻ (1)

ClF₃→ClF+2F⁺ (2)

The reactivity of the cleaning gas against SiC generally depends on the various chemical properties, such as bond dissociation energy and ionicity, of the cleaning gas. The bond dissociation energy is herein considered as one important factor. The lower the bond dissociation energy of the cleaning gas compound, the higher the reaction rate of the cleaning gas compound against SiC. It is thus assumed that the reactivity of ClF₃ against SiC is high as ClF₃ has a lower bond dissociation energy than those of fluorinated iodine compounds such as IF₇ and IF₅ (see TABLE 1 below).

Herein, the data about F₂ in TABLE 1 is a quotation from “An Introduction to Fluorine Chemistry 2010” edited by Japan Society for Promotion of Science, 155 Fluorine Chemistry Committee and published by Sankyo Publishing Co., Ltd, 2010, p. 2; and the data about ClF₃, IF₇ and IF₅ in TABLE 1 is a quotation from J. C. BAILAR JR., COMREHENSIVE INORGANIC CHEMISTRY I, PERGAMON PRESS Ltd., 1973, p. 1491-1496.

TABLE 1

| Molecular formula X—F | F₂ | ClF₃ | IF₇ | IF₅ |
|---|---|---|---|---|
| X—F Bond energy kJ/mol | 150 | 175 | 233 | 270 |

The present inventors have however found as a result of extensive researches that the iodine heptafluoride has a specific feature of showing a higher reaction rate against silicon carbide than that of ClF₃, without causing damage to graphite, in a state of being heated to 150° C. or higher (see the after-mentioned examples) even though the bond dissociation energy of the iodine heptafluoride is relatively high. The mechanism of such reaction mechanism has not been made clear. As the lower fluorinated iodine compound (IF₅) generated as the product of the thermal decomposition of the iodine heptafluoride is larger in molecular size than ClF generated as the product of the thermal decomposition of ClF₃, it is assumed that the molecular size of such a reaction product provides an effect on the protection of graphite. It is further assumed that the reactivity against the silicon carbide is due to reaction of not only the fluorine radicals but also the fluorinated iodine compound such as IF₇ or IF₅ with the silicon carbide.

As to the cleaning conditions, there is no particular restriction on the temperature of the base with the silicon carbide-containing deposit. The temperature of the base is generally in the range of 150 to 700° C., preferably 300 to 600° C. If the cleaning is performed at a temperature lower than 150° C., thermally undecomposed iodine heptafluoride may enter and form a compound between graphite layers and thereby unfavorably fail to achieve sufficient cleaning performance. It is waste of energy so that there arises an unfavorable increase of running cost such as power consumption if the cleaning is performed at a temperature higher than 700° C.

There is also no particular restriction on the processing pressure during the cleaning. Although it is preferable to perform the cleaning under a reduced pressure, the cleaning may be performed at atmospheric pressure. Under temperature conditions exceeding 500° C., the processing pressure is preferably 13.3 kPa (100 Torr) or lower, more preferably 6.6 kPa (50 Torr) or lower. If the processing pressure exceeds 13.3 kPa (100 Torr), there may unfavorably occur corrosion.

Further, the flow rate of the cleaning gas used is adjusted as appropriate depending on the capacity of the reactor in the equipment to be cleaned.

In the present invention, the cleaning is generally performed by thermal decomposition. of the Cleaning gas in view of ease of operation, cost and the like. It is alternatively feasible to adopt any other excitation process such as photo decomposition or plasma excitation. The cleaning gas of the present invention enables efficient removal of the silicon carbide by plasma-less heating treatment and has the advantages of no load on the equipment material as well as less restriction on the equipment for creating a plasma atmosphere inside the equipment.

The cleaning method of the present invention can be applied to equipment for production of silicon carbide films by CVD process in semiconductor devices, coated tools etc. or equipment for production of silicon carbide whiskers, powders etc. The cleaning method of the present invention can be applied for cleaning of not only a reactor inner wall or attachment device of silicon carbide thin or thick film production equipment but also a reactor inner wall or attachment device of other production equipment such as equipment for production of hexagonal SIC crystal wafers by large-size bulk crystal growth. Among others, it is preferable to apply the cleaning method of the present invention to silicon carbide film production equipment. As such film production equipment, particularly preferred is equipment for producing silicon carbide epitaxial films under high-temperature conditions.

### EXAMPLES

The present invention will be described in more detail below by way of the following examples. It should be understood that the following examples are illustrative and are not intended to limit the present invention thereto.

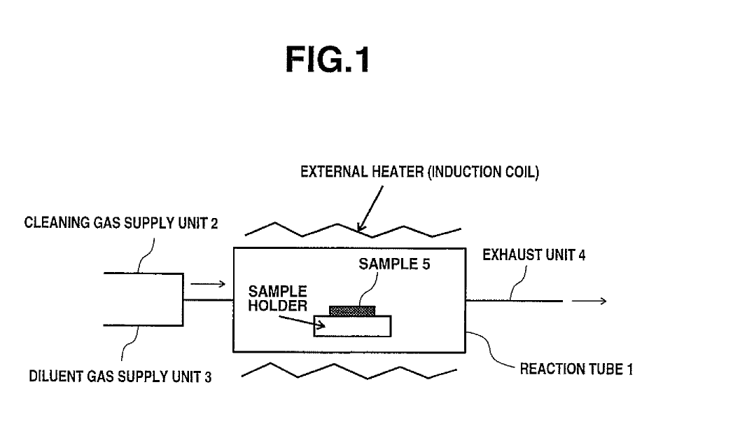

FIG. 1 is a schematic view of a cleaning apparatus used in each of Examples and Comparative Examples.

As shown in FIG 1, the cleaning apparatus had an external heating type lateral reaction furnace equipped with a cylindrical reaction tube 1 (made of alumina) as a reactor. A cleaning gas supply unit 2 and a diluent gas supply unit 3 were connected to the cylindrical reaction tube 1. A discharge unit 4 is connected to the downstream side of the reaction tube 1 so as to discharge gas out of the reaction tube. An induction heating coil was provided as an external heater to the outer circumference of the reaction tube 1 so that the inside of the reaction tube was heated by the induction coil. The following cleaning test was performed by placing, as a sample 5, a single-crystal silicon carbide film and a graphite plate within the reaction tube.

In the cleaning test, the cleaning rate of the silicon carbide film was tested using the cleaning gas of the present invention and the cleaning apparatus of FIG. 1. Simultaneously, the weight change rate of the graphite plate before and after the cleaning test was tested in order to examine the influence of cleaning on graphite. The weight change rate of the graphite plate was determined as a difference in the weight of the graphite plate measured before and after the cleaning test. TABLE 2 shows the cleaning conditions and the graphite weight change rate test results of Examples and Comparative Examples. Herein, the cleaning rate was determined based on the weight change of the sample by the following general formula (3).

$$Cleaning rate = \frac{( {w}_{i} - {w}_{f} ) a}{{w}_{f} t} \\ t \text{:} cleaning time , a \text{:} initial film thickness , {w}_{i} \text{:} initial weight , {w}_{t} \text{:} weight after test \qquad ( 3 )$$

### Example 1

The single-crystal CVD silicon carbide film and the graphite plate (each formed with a width of 0.5 cm, a length of 1 cm and a thickness of 0.5 mm) were inserted as the test sample in the reactor. While the heater external to the reactor was heated to 250° C., iodine heptafluoride (IF₇) gas was supplied from the gas supply unit into the reactor at a flow rate of 0.1 L/min such that the internal pressure of the reactor was maintained at 6.6 kPa (50 torr) for 1 hour. The graphite plate used herein was that available from Nilaco Corporation (purity: 99.99%). As a result, the cleaning rate of the silicon carbide film was 10 nm/min; and the weight change rate of the graphite plate was 0.02% per 1 hour,

### Example 2

The cleaning test was performed under the same conditions as in Example 1, except that the temperature of the reactor was set to 300° C. As a result, the cleaning rate of the silicon carbide film was 26 nm/min; and the weight change rate of the graphite plate was 0.10% per 1 hour.

### Example 3

The cleaning test was performed under the same conditions as in Example 1, except that the temperature of the reactor was set to 350° C. As a result, the cleaning rate of the silicon carbide film was 56 nm/min; and the weight change rate of the graphite plate was 0.48% per 1 hour.

### Example 4

The cleaning test was performed under the same conditions as in Example 1, except that the temperature of the reactor was set to 400° C. As a result, the cleaning rate of the silicon carbide film was 212 nm/min; and the weight change rate of the graphite plate was 1.2% per 1 hour.

### Example 5

The cleaning test was performed under the same conditions as in Example 1, except that the temperature of the reactor was set to 500° C. As a result, the cleaning rate of the silicon carbide film was 710 nm/min; and the weight change rate of the graphite plate was 2.2% per 1 hour.

### Example 6

The cleaning test was performed under the same conditions as in Example 4, except that the internal pressure of the reactor was set to 101 kPa (760 Torr). As a result, the cleaning rate of the silicon carbide film was 526 nm/min; and the weight change rate of the graphite plate was 3.0% per 1 hour.

### Example 7

The cleaning test was performed under the same conditions as in Example 4, except that: the cleaning gas used was a mixed gas of 10 vol % iodine heptafluoride and 90 vol % nitrogen (N₂); and the internal pressure of the reactor was set to 66.7 kPa (500 Torr). As a result, the cleaning rate of the silicon carbide film was 231 nm/min; and the weight change rate of the graphite plate was 1.6% per 1 hour.

### Example 8

The cleaning test was performed under the same conditions as in Example 3, except that the cleaning gas used was a mixed gas of 50 vol % iodine heptafluoride and 50 vol % hydrogen fluoride (HF). As a result, the cleaning rate of the silicon carbide film was 66 nm/min; and the weight change rate of the graphite plate was 0.36% per 1 hour. It is apparent from the test result of Example 8 that it is possible to improve the cleaning rate by the addition of hydrogen fluoride.

### Example 9

The cleaning test was performed under the same conditions as in Example 3, except that the cleaning gas used was a mixed gas of 25 vol % iodine heptafluoride and 75 vol % oxygen (O₂). As a result, the cleaning rate of the silicon carbide film was 195 nm/min; and the weight change rate of the graphite plate was 0.38% per 1 hour. It is apparent from the test result of Example 9 that it is possible to significantly improve the cleaning rate by the addition of oxygen.

### Example 10

The cleaning test was performed under the same conditions as in Example 3, except that the cleaning gas used was a mixed gas of 50 vol % iodine heptafluoride and 50 vol % oxygen (O₂). As a result, the cleaning rate of the silicon carbide film was 228 nm/min; and the weight change rate of the graphite plate was 0.45% per 1 hour.

### Example 11

The cleaning test was performed under the same conditions as in Example 3, except that the cleaning gas used was a mixed gas of 75 vol % iodine heptafluoride and 25 vol % oxygen (O₂). As a result, the cleaning rate of the silicon carbide film was 179 nm/min; and the weight change rate of the graphite plate was 0.45% per 1 hour.

### Example 12

The cleaning test was performed under the same conditions as in Example 1, except that the temperature of the reactor was set to 200° C. As a result, the cleaning rate of the silicon carbide film was lower than those of the other examples. There was however seen almost no weight change in the graphite plate.

### Example 13

The cleaning test was performed under the same conditions as in Example 3, except that the cleaning gas used was a mixed gas of 75 vol % iodine heptafluoride and 25 vol % nitrogen dioxide (NO₂). As a result, the cleaning rate of the silicon carbide film was 141 nm/min; and the weight change rate of the graphite plate was 0.43% per 1 hour.

### Example 14

The cleaning test was performed under the same conditions as in Example 3, except that the cleaning gas used was a mixed gas of 50 vol % iodine heptafluoride and 50 vol % nitrogen dioxide (NO₂). As a result, the cleaning rate of the silicon carbide film was 151 mn/min; and the weight change rate of the graphite plate was 0.46% per 1 hour.

### Example 15

The cleaning test was performed under the same conditions as in Example 3, except that the cleaning gas used was a mixed gas of 25 vol % iodine heptafluoride and 75 vol % nitrogen dioxide (NO₂). As a result, the cleaning rate of the silicon carbide film was 157 nm/min; and the weight change rate of the graphite plate was 0.43% per 1 hour.

### Example 16

The cleaning test was performed under the same conditions as in Example 3, except that the cleaning gas used was a mixed gas of 25 vol % iodine heptafluoride and 75 vol % nitrogen monoxide (NO). As a result, the cleaning rate of the silicon carbide film was 89 nm/min; and the weight change rate of the graphite plate was 0.07% per 1 hour.

### Example 17

The cleaning test was performed under the same conditions as in Example 3, except that the cleaning gas used was a mixed gas of 50 vol % iodine heptafluoride and 50 vol % nitrogen monoxide (NO). As a result, the cleaning rate of the silicon carbide film was 879 nm/min; and the weight change rate of the graphite plate was 0.42% per 1 hour.

### Example 18

The cleaning test was performed under the same conditions as in Example 3, except that the cleaning gas used was a mixed gas of 75 vol % iodine heptafluoride and 25 vol % nitrogen monoxide (NO). As a result, the cleaning rate of the silicon carbide film was 1050 nm/min; and the weight change rate of the graphite plate was 0.44% per 1 hour.

### Comparative Example 1

The cleaning gas was performed under the same conditions as in Example 2, except that chlorine trifluoride gas was used in place of the iodine :heptafluoride gas. As a result, the etching rate of the silicon carbide film was 7 nm/min and was lower than that in the case of using the iodine heptafluoride. Further, the weight change rate of the graphite plate was 0.1% per 1 hour and was greater than that in the case of using the iodine heptafluoride.

### Comparative Example 2

The cleaning gas was performed under the same conditions as in Example 3, except that chlorine trifluoride gas was used in place of the iodine heptafluoride gas. As a result, the etching rate of the silicon carbide film was 30 nm/min and was lower than that in the case of using the iodine heptafluoride. Further, the weight change rate of the graphite plate was 1% per 1 hour and was greater than that in the case of using the iodine heptafluoride.

### Comparative Example 3

The cleaning gas was performed under the same conditions as in Example 4, except that chlorine trifluoride gas was used in place of the iodine heptafluoride gas. As a result, the etching rate of the silicon carbide film was 93 nm/min and was lower than that in the case of using the iodine heptafluoride. Further, the weight change rate of the graphite plate was 2% per 1 hour and was greater than that in the case of using the iodine heptafluoride.

### Comparative Example 4

The cleaning gas was performed under the same conditions as in Example 2, except that fluorine gas was used in place of the iodine heptafluoride gas. As a result, the etching rate of the silicon carbide film was 28 mn/min and was equivalent to that in the case of using the iodine heptafluoride. However, the weight change rate of the graphite plate was 0.1% per 1 hour and was greater than that in the case of using the iodine heptafluoride.

### Comparative Example 5

The cleaning gas was performed under the same conditions as in Example 3, except that fluorine gas was used in place of the iodine heptafluoride gas. As a result, the etching rate of the silicon carbide film was 146 nm/min and was higher than that in the case of using the iodine heptafluoride. However, the weight change rate of the graphite plate was 2% per 1 hour and was greater than that in the case of using the iodine heptafluoride.

### Comparative Example 6

The cleaning gas was performed under the same conditions as in Example 4, except that fluorine gas was used in place of the iodine heptafluoride gas. As a result, the etching rate of the silicon carbide film was 350 nm/min and was higher than that in the case of using the iodine heptafluoride. However, the weight change rate of the graphite plate was 3% per 1 hour and was greater than that in the case of using the iodine heptafluoride.

As is seen from the test results of Examples 1 to 18 and Comparative Examples 1 to 6, the iodine heptafluoride (IF₇) had better cleaning performance than those of other fluorinated halogen gas (such as ClF₃) and fluorine gas and did not cause remarkable damage to graphite (i.e. did not cause etching of graphite). It has thus been shown that the iodine heptafluoride (IF₇) is good cleaning gas for selectively removing a silicon carbide deposit without causing large damage to graphite.

TABLE 2

| | | | | | Cleaning rate | Weight change rate |
|---|---|---|---|---|---|---|
| | Kind of | Volume | Pressure | Temp. | (mn/min) | (%/1 h) |
| | gas | (%) | (kPa) | (° C.) | of SiC film | of graphite plate |
| Example 1 | IF₇ | 100 | 6.6 | 250 | 10 | 0.02 |
| Example 2 | IF₇ | 100 | 6.6 | 300 | 26 | 0.10 |
| Example 3 | IF₇ | 100 | 6.6 | 350 | 56 | 0.48 |
| Example 4 | IF₇ | 100 | 6.6 | 400 | 212 | 1.2 |
| Example 5 | IF₇ | 100 | 6.6 | 500 | 710 | 2.2 |
| Example 6 | IF₇ | 100 | 101 | 400 | 526 | 3.0 |
| Example 7 | IF₇/N₂ | 10/90 | 66 | 400 | 231 | 1.6 |
| Example 8 | IF₇/HF | 50/50 | 6.6 | 350 | 66 | 0.36 |
| Example 9 | IF₇/O₂ | 25/75 | 6.6 | 350 | 195 | 0.38 |
| Example 10 | IF₇/O₂ | 50/50 | 6.6 | 350 | 228 | 0.45 |
| Example 11 | IF₇/O₂ | 75/25 | 6.6 | 350 | 179 | 0.45 |
| Example 12 | IF₇ | 100 | 6.6 | 200 | 3 | 0.05 |
| Example 13 | IF₇/NO₂ | 25/75 | 6.6 | 350 | 141 | 0.43 |
| Example 14 | IF₇/NO₂ | 50/50 | 6.6 | 350 | 151 | 0.46 |
| Example 15 | IF₇/NO₂ | 75/25 | 6.6 | 350 | 157 | 0.43 |
| Example 16 | IF₇/NO | 25/75 | 6.6 | 350 | 89 | 0.07 |
| Example 17 | IF₇/NO | 50/50 | 6.6 | 350 | 879 | 0.42 |
| Example 18 | IF₇/NO | 75/25 | 6.6 | 350 | 1050 | 0.44 |
| Comparative | ClF₃ | 100 | 6.6 | 300 | 7 | 0.20 |
| Example 1 | | | | | | |
| Comparative | ClF₃ | 100 | 6.6 | 350 | 30 | 2.0 |
| Example 2 | | | | | | |
| Comparative | ClF₃ | 100 | 6.6 | 400 | 93 | 4.0 |
| Example 3 | | | | | | |
| Comparative | F₂ | 100 | 6.6 | 300 | 28 | 0.2 |
| Example 4 | | | | | | |
| Comparative | F₂ | 100 | 6.6 | 350 | 146 | 4.0 |
| Example 5 | | | | | | |
| Comparative | F₂ | 100 | 6.6 | 400 | 350 | 8.0 |
| Example 6 | | | | | | |

The cleaning gas and cleaning method of the present invention is useful for removal of unnecessary deposits in silicon carbide production equipment such as those for production of silicon carbide epitaxial films or large-size silicon carbide bulk crystals.

1. A cleaning gas for removing a silicon carbide-containing deposit on a base of at least partially graphitized carbon, the cleaning gas comprising iodine heptafluoride.

2. The cleaning gas according to claim 1, further comprising at least one kind of oxidizing gas selected from the group consisting of F₂, ClF₃, COF₂, O₂, O₃, NO, NO₂, N₂O and N₂O₄.

3. The cleaning gas according to claim 1, further comprising at least one kind of inert gas selected from the group consisting of He, Ne, Ar, Xe, Kr and N₂.

4. The cleaning gas according to claim 1, wherein the base is an inner wall or attachment device of silicon carbide single crystal production equipment.

5. The cleaning gas according to claim 4, wherein the silicon carbide single crystal production equipment is for production of silicon carbide epitaxial films.

6. A cleaning method comprising, while heating a base of at least partially graphitized carbon, removing a silicon carbide-containing deposit on the base by the cleaning gas according to claim 1.

7. The cleaning method according to claim 6, wherein the cleaning gas is brought into contact with the base while the base is heated to a temperature of 150 to 700° C.

8. The cleaning method according to claim 6, wherein the cleaning gas further comprises at least one kind of oxidizing gas selected from the group consisting of F₂, ClF₃, COF₂, O₂, O₃, NO, NO₂, N₂O and N₂O₄.

9. The cleaning method according to claim 6, wherein the cleaning gas further comprises at least one kind of inert gas selected from the group consisting of He, Ne, Ar, Xe, Kr and N₂.
